(19) United States
(12) Patent Application Publication
(10) Pub. No.: US 2001/0008678 A1
(43) Pub. Date: Jul. 19, 2001

(54) SKELETAL SUSPENSION SYSTEM

(76) Inventor: JEFFREY HOFFMAN, FOUNTAIN HILLS, AZ (US)

Correspondence Address: JENNIFER H HAMMOND, SONNENSCHEIN NATH & ROSENTHAL, 4520 MAIN ST, SUITE 1100, KANSAS CITY, MO, 64111

(21) Appl. No.: 09/193,166

(22) Filed: Nov. 16, 1998

(51) Int. Cl. B32B 3/10

(52) U.S. Cl. 428/138

(57) ABSTRACT

A shock absorbing system for absorbing and returning energy in response to an impact comprised of two solid materials: an elastomeric foam and elastomer gel. The elastomeric foam is formed into a foam skeleton having at least two spaces within the foam skeleton for receiving the elastomer gel. At least two solid pieces of elastomer gel are formed to be integrally positioned within a corresponding space in the elastomeric skeleton such that all spaces within the foam skeleton are filled with the elastomer gel.

### FIELD OF THE INVENTION

The present invention relates to a suspension and shock absorbing system that both absorbs and returns energy. In particular, the present invention relates to a skeletal suspension system comprised of polyurethane and a solid elastomer gel for use preferably in the midsole of a shoe that both absorbs the energy associated with the impact experienced by a wearer of the shoe when engaged in athletic activity and returns the energy to the wearer.

### BACKGROUND OF THE INVENTION

The search for cost-effective shock absorbing devices for various applications has been an on-going quest. This quest is readily apparent in the athletic footwear industry. It is well known that when a person walks, jogs, jumps, or runs, a considerable amount of energy is dissipated by raising the foot and then lowering it to the ground. When the foot contacts the ground, a shock force is transmitted through the shoe to the wearer's foot. After a time, this shock force can result in fatigue, discomfort, and injury to the wearer. Thus, good energy absorption is an essential property for athletic shoes. Moreover, performance of an athletic shoe can be improved when the shoe efficiently returns energy to the wearer. Thus, the ideal athletic shoe should be capable of storing some of the absorbed energy and returning it in a spring-like fashion to assist in propelling the wearer.

Generally, an athletic shoe includes three major elements: an upper, a midsole, and an outsole. The upper is designed to snugly and comfortably enclose the wearer's foot while the outsole contacts the ground. The midsole is positioned between the upper and the outsole. Because the outsole is in contact with the ground, the outsole is usually made of a durable material that provides both traction and high abrasion resistance, such as rubber or other like substance.

The midsole, or the structure of the sole interior, is the primary mechanism for both shock-absorption (also known as energy absorption) and energy return. A midsole with “high” energy absorption characteristics has relatively “low” resiliency and generally does not return much of the energy placed into the midsole at the point of impact, resulting in a “flat” feel and less efficient foot motion. In contrast, a midsole with “low” energy absorption has relatively “high” resiliency and returns more of the energy imparted to the midsole at the point of impact. A desirable midsole, therefore, is one in which the impact response contains the appropriate balance of shock absorption and energy return.

A considerable amount of research and development has been carried out in recent years to improve the midsoles of shoes, especially athletic shoes designed for running and/or jumping. Various shock absorbing materials have been utilized in the midsole to absorb the shock. Conventional soles are generally comprised of an elastomeric foam such as ethylene vinyl acetate (EVA) or polyurethane (PU), or other viscoelastic, polymeric, expanded closed foam materials. The prior art suggests that an elastomeric foam midsole material by itself is generally inadequate to provide the stability and cushioning demanded for modern sport shoes. This is because the high density, hardness foams cannot absorb energy and therefore cause injury to the wearer. In contrast, lower density, hardness foams are too soft and bottom out too quickly because the foams collapse to a point where they no longer function as a shock absorber. Thus, the problems associated with the use of completely foam midsoles have prompted several approaches for improving the energy absorbing characteristics of the midsole.

In an attempt to overcome these difficulties with completely foam midsoles, conventional midsoles have incorporated a cushioning system comprised of a plurality of chambers filled with either a gas or liquid. Filler gases typically include air, nitrogen, or freon. Filler liquids have included water, glycol mixtures, glycerin, various oils, and other relatively low viscosity liquids.

For example, some recent conventional cushioning systems have utilized chambers filled with a nonelastic gel material for absorbing energy. For example, Ito U.S. Pat. No. 4,768,295 describes a plurality of non-elastically deformable gel-filled chambers. When a shock is applied to the heel portion of the shoe, the gel undergoes a nonelastic deformation similar to that of a liquid, thus absorbing the shock instantly. Likewise, Bates et al. U.S. Pat. No. 5,155,927 describes an athletic shoe that has at least one cushioning element in the sole of the shoe. The cushioning element is comprised of a chamber filled with a liquid gel composition.

Other chambers use a combination of the above materials to absorb energy. For example, both Yamashita U.S. Pat. No. 5,718,063 and Hoppenstein U.S. Pat. No. 5,64,202 utilize a combination of gas-filled and liquid gel-filled chambers. Likewise, U.S. Pat. No. 5,667,887 to Jenker uses a hydrophilic polymer in combination with a liquid to form a gel-like colloidal fluid in the chamber.

One problem with all such conventional midsoles is that they are passive systems, focusing only on energy absorption. In other words, the chamber of the cushioning systems are filled with air, liquid, or nonelastic gels that absorb energy but do not return it in an active manner. Another problem with the prior art midsoles is that the shock absorbing capability of the sole decreases if the shocks are applied repeatedly in short time intervals. For example, when an athlete runs, repeated shocks are applied to the cushioning system before the system can come back to its original state. As a result of this displacement, the absorbing capability of the sole significantly decreases with the repeated impact over such short time intervals. In short, the gel will bottom out and the energy absorbing capabilities will be greatly reduced.

Additionally, another problem with conventional midsoles is that the gaseous or fluid filled chambers may shrink or leak over time. For example, it is estimated that an air system can lose 50% of its shock absorbing capabilities over time. Finally, conventional cushioning systems, especially those using air, tend to create heat. Because the systems must be closed cell systems to prevent the gas or liquid from leaking, the systems cannot transfer heat to the surroundings. This heat can ultimately cause discomfort to the wearer.

Unlike the present invention, the prior art shock absorbing systems do not provide a stable platform for the wearer. Thus, injury may result to the wearer despite the cushioning and shock absorbing properties of the systems. One example of a common injury resulting from these prior art systems is the injury occurring to the Achilles tendon of a wearer of a shoe utilizing air pockets for cushioning and shock absorbing. Although these prior art systems have been successful in both absorbing shock and providing cushioning, these prior art systems have not been stable enough to provide adequate support to the wearer to prevent injury or return the absorbed energy to the wearer.

Accordingly, the present invention addresses the problems associated with conventional midsoles by providing a suspension system that may be incorporated into conventional midsoles and that both efficiently stores and returns energy to the wearer. The suspension system is comprised of a resilient cushioning material that does not bottom out, but returns quickly to its original state, thereby returning energy and maximizing subsequent absorbing capabilities. Additionally, the present invention provides an open-celled suspension system comprised of stable compounds that do not shrink or leak over time and thus, provides a stable platform for the wearer of an athletic shoe utilizing such suspension system.

### SUMMARY OF THE INVENTION

It is the primary object of this invention to provide a novel midsole for use in athletic shoes that both absorbs and returns energy.

Yet another object of the present invention provides a midsole that has a high amount of resilience and that allows the system to quickly return to its original state.

Still another object of the present invention is to maximize the absorbing capabilities of the cushioning system when repeated shocks are applied to the system over a short period of time.

The present invention has been described as a suspension system for absorbing and returning energy in response to an impact. While the present invention is described, it is to be understood that the presently disclosed suspension system can be used in additional structures where it is desired to absorb and return energy developed during the impact as it may be used in an athlete shoe, between two elements.

In accordance with these and other objects, the present invention provides a suspension system for absorbing and returning energy in response to an impact; the suspension system being comprised of two solid materials: an elastomeric foam and an elastomer gel. The elastomeric foam is formed into a foam skeleton having at least two spaces within the foam skeleton for receiving the elastomer gel. At least two solid pieces of elastomer gel are formed to be integrally positioned within a corresponding space in the elastomeric skeleton such that all spaces within the foam skeleton are filled with the elastomer gel.

### BRIEF DESCRIPTION OF THE DRAWINGS

FIG. 1 is a plan view of the foam skeleton of the present invention.

FIG. 2 is a cross sectional view of the foam skeleton of the present invention taken along line 1-1 of FIG. 1.

FIG. 3 is a plan view of the skeletal suspension system of the present invention.

FIG. 4 is a cross sectional view of the skeletal suspension system of FIG. 3 taken along line 3-3.

FIG. 5 is a perspective view of an athletic shoe.

FIG. 6 is a cut-away side view of the midsole of the athletic shoe as illustrated in FIG. 5.

FIG. 7 is a perspective view of a midsole of the athletic shoe in FIG. 5 illustrating a cavity in the midsole for receiving the skeletal suspension system of the present invention.

FIG. 8 is a perspective view of the midsole as shown in FIG. 7 having the skeletal suspension system positioned within the cavity of the midsole.

### DETAILED DESCRIPTION OF THE DISCLOSURE

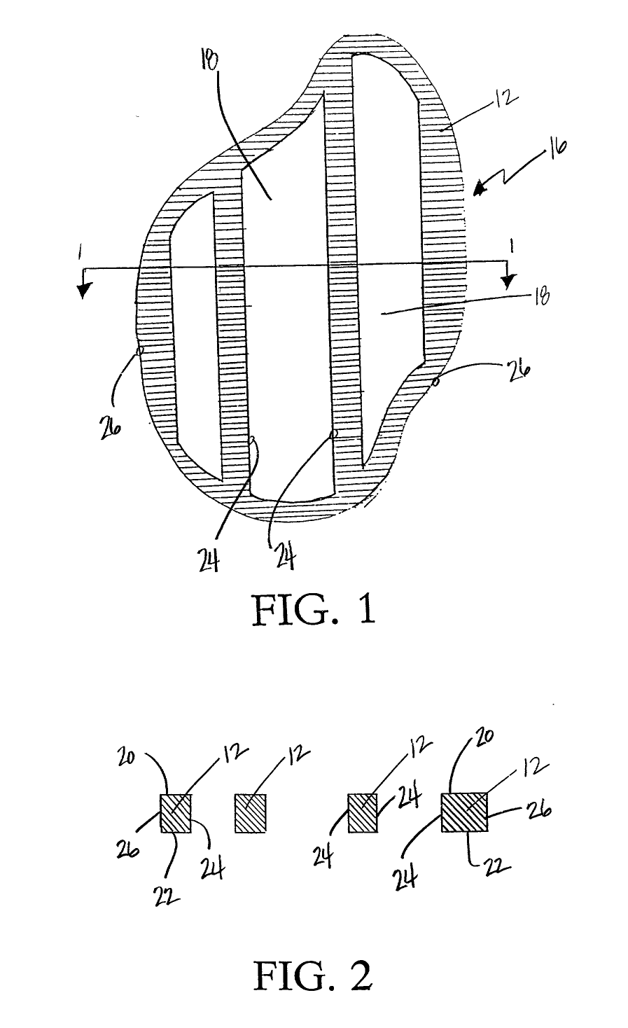

As seen in FIGS. 1-4, the present invention relates to a unique shock absorbing or skeletal suspension system 10 comprised of two solid mass materials: an elastomeric foam 12 and an elastomer gel 14. For purposes of clarity, the elastomeric foam 12 is represented in the drawings with hatching and the elastomer gel 14 is shaded.

In the preferred embodiment, the elastomeric foam 12 is formed into a foam skeleton 16 having a plurality of spaces 18 for receiving elastomer gel 14. As seen in FIGS. 1 & 2, the foam skeleton 16 of the present invention also has a generally flat upper surface 20, a generally flat lower surface 22, inner walls 24 defining the plurality of spaces 18 in the foam skeleton 16 and an exterior wall 26. In the preferred embodiment, the foam skeleton 16 is comprised of polyurethane; however, other elastomeric foams such as EVA or other viscoelastic polymeric, expanded closed foam materials may be utilized. In its preferred embodiment, the polyurethane material has a durometer range of 50 d to 65 d for maximum energy return. It is recognized, however, that foams of other suitable durometer values may be used, but a firm durometer polyurethane, such as that utilized in the present invention, will return about 85% of the energy directed at the system 10.

Unlike other low viscosity gels typically employed in shock absorbing systems, the elastomer gel 14 is a solid elastic material that does not flow upon impact. In its preferred embodiment, the gel has a durometer range of 30 d to 45 d; however, it is recognized that other suitable durometer values may be used. The preferred gel 14 for use in the present invention is the mineral oil based gel manufactured by Silopos, Inc., a company located in Niagara Falls, N.Y., that manufactures the gel for sale to the medical industry. Although the gel manufactured by Silopos is preferred for use in the present invention, other gels may be utilized that have a low viscosity rate and do not flow upon impact.

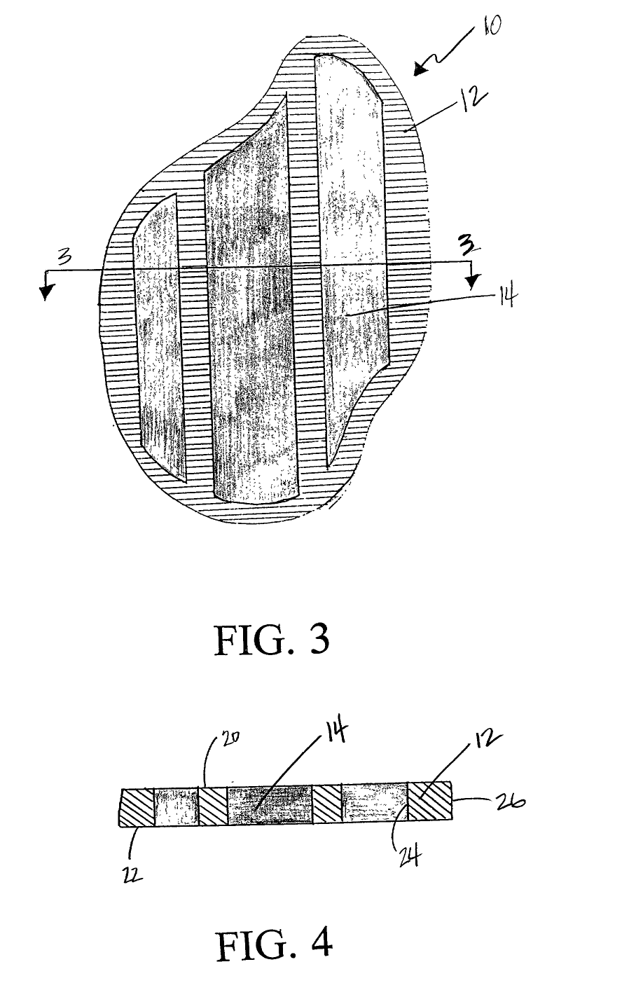

As seen in FIGS. 3 & 4, the elastomer gel 14 of the present invention fills the spaces 18 in the foam skeleton 16 such that every space 18 in the skeleton 16 is filled by a piece of elastomer gel 14. Since the gel 14 is solid, the gel 14 is formed such that one piece of elastomer gel 14 fits within a corresponding space 18 in the skeleton 16. Each piece of elastomeric gel 14 corresponds in shape and size to a corresponding space 18 in the skeleton 16. Each piece of gel 14 has (1) exterior walls 28 that correspond to the interior walls 24 of the skeleton 16; (2) a generally flat upper surface 30; and (3) a generally flat lower surface 32. As seen in FIG. 4, the upper and lower surfaces 30 and 32 of each piece of gel 14 are flush with the upper and lower surfaces 20 and 22 of the skeleton 16 when positioned within the spaces 18 of the skeleton 16.

It is preferred that at least two spaces 18, but generally more, be provided within the foam skeleton 12 such that the skeleton 12 and gel 14 can work together during impact to absorb and then return energy. It is preferred that the spaces 18 formed in the foam skeleton 16 for receipt of the elastomer gel 14 be approximately 3-8 mm in width and span the entire length of the foam skeleton 16. This may, however, vary depending upon the particular use of the shock absorbing system 10.

Unlike the passive use of polyurethane to house the air/liquid/gel in the prior art, the foam skeleton 16 of the shock absorbing system 10 plays an active role in the system's energy return mechanism. While the gel 14 absorbs the shock, the foam skeleton 16, working in conjunction with the gel 14, acts to return energy to the surrounding environment by assisting the elastomer gel 14 in returning to its full and original shape prior to the next impact.

The dual function of this suspension system 10 is accomplished by partially surrounding at least two pieces of gel 14, within the confines of a foam skeleton 16, adjacent to one another and separated by a piece of elastomeric foam 12. Upon impact, the elastomer gel 14 deforms to absorb and dissipate the shock of the impact and then immediately returns to its original state to absorb the impact of the next shock. Although the gel 14 is a naturally resilient material because of its solid state, the resilience of the gel 14 is increased by the interior walls 24 of the surrounding elastomer foam skeleton 16. These interior walls 24 act to resist the deformation of the gel 14 upon impact and force the gel 14 quickly back to its original state, thereby allowing the system to return the stored energy.

Additionally, by using more than one piece of solid elastomer gel 14 positioned adjacent one another and separated by a wall of elastomer foam 12, the return rate of the gel 14 to its original state is increased. The deformation of each opposing gel 14 will act against the other, causing the intervening elastomer foam 12 to create even more resistance against each piece of gel 14, again, increasing the natural resilience of the elastomer gels 14 and creating a more effective and efficient shock absorbing system 10 that also returns the absorbed energy. Accordingly, the system 10 allows for maximum shock absorption and energy return with each impact.

The shock absorbing system 10 of the present invention has a variety of uses. For example, the system can be used in connection with any padded device used to protect a person from bodily harm, such as a helmet, knee pads, tennis shoes, gloves and other types of protective gear. The utilization of the elastomer foam and gel in contact with one another may also be used in objects that the human body comes into contact with, such as a steering wheel, dashboard, or running track. Finally, the system can be utilized in other situations where it is not only desirable to absorb an impact but also to return the absorbed energy following impact. As further described below, the present shock absorbing system 10 is especially useful in athletic shoes.

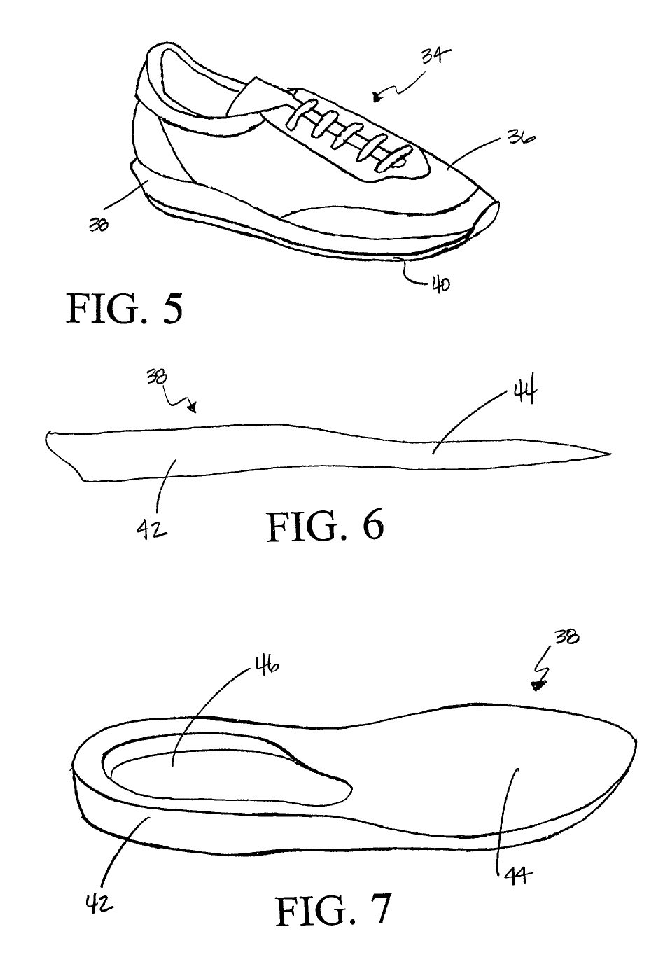

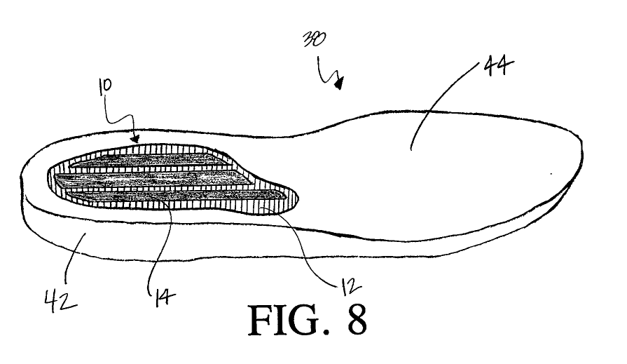

As seen in FIG. 5, an athletic shoe 34 is generally comprised of three major elements: an upper 36, a midsole 38, and an outsole 40. In the athletic shoe 34, the shock absorbing system 10 is located integrally within the midsole 38 of a shoe (See FIG. 6) either (1) in the heel region 42 of the midsole 38, as seen in FIGS. 7-8; (2) at the front region 44 of the midsole 38 near the ball of the foot (not shown); or (3) in both the heel region 42 of the midsole 38 and the front region 44 of the midsole 38 (not shown). Additionally, the suspension system 10 could be designed as the entire midsole 38 of the shoe 34; in which case, the spaces 18 in the system 10 for receiving the gel 14 would extend nearly the entire length of the midsole 38.

When the skeletal suspension system 10 is in the heel region 42 of the midsole 38, as seen in FIGS. 7 & 8, a cavity 46 is molded or cut into the midsole 38 for placement of the suspension system 10 within the midsole 38. The shock absorbing system 10 is then integrally placed inside the cavity 46 of the midsole 38. When used in connection with an athletic shoe 34, this shock absorbing system 10 is dimensioned to be flush with the top and bottom surfaces of the midsole 38; however, the system 10 could be completely encapsulated within the midsole or positioned within the midsole 38 so that only one surface is flush with a surface of the midsole 38. For example, in an adult size athletic shoe 34, the cavity 46 is approximately 7 mm in depth, 55 mm in width, and 100 mm long. The skeletal suspension system 10 then has dimensions corresponding to the cavity 46 so that the system 10 fits snugly into the cavity 46.

Unlike the prior shock absorbing system, this suspension system 10, when used in connection with an athletic shoe 34, provides the dual functions of absorbing energy upon impact and returning energy to the foot of the wearer as the foot is lifted, thereby reducing fatigue and injury to the user. During use, the gel 14 absorbs energy in all directions. However, unlike the gels utilized in the prior art, the solid gel 14 used in conjunction with the polyurethane skeleton 16 will not bottom out with each subsequent impact. Much like a suspension system on a car, one mechanism (the elastomer gel) absorbs energy while another mechanism (the polyurethane) returns it. Thus, the system allows for maximum shock absorption and energy return with each impact.

As discussed above, the present invention is most useful in athletic shoes 34 where the skeletal suspension system 10 is within the midsole 38 of the shoe 34 at either the heel portion 42, the front portion 44 or both. It should, however, be understood that the suspension system 10 of the present invention can be incorporated into many other cushioning devices where the absorption and return of energy is desirable. Moreover, it should be understood that the materials of equivalent characteristics described herein are given by way of example and that a number of materials can be utilized to construct a skeletal suspension system 10 in accordance with the present invention. The energy-absorbing characteristics of the solid elastomer gel 14 and the energy-returning characteristics of the polyurethane skeleton 16 can be varied to provide the desired combination of energy control for the particular application.

While the present invention has been disclosed in reference to the disclosed embodiments, other arrangements will be apparent to those of ordinary skill in the art and are to be considered within the spirit and scope of the present invention. The invention is, therefore, to be limited only as indicated by the scope of the claims that follow and their equivalents.

I claim:

1. A suspension system for absorbing and returning energy in response to an impact, said suspension system comprising:
an elastomeric foam skeleton, said skeleton having at least two spaces within said foam skeleton; and
at least two pieces of solid elastomer gel, each piece being integrally positioned within a corresponding space in said foam skeleton.

2. A suspension system as recited in claim 1, wherein said elastomeric foam skeleton is comprised of polyurethane.

3. A suspension system as recited in claim 1, wherein said elastomeric foam skeleton has a durometer range of 50 d to 65 d.

4. A suspension system as recited in claim 1, wherein the solid elastomer gel has a durometer range of 30 d to 45 d.

5. A suspension system as recited in claim 1, wherein each of the spaces in the foam polyurethane skeleton ranges between 3 to 8 mm in width.

6. A suspension system for absorbing and returning energy in response to an impact, said suspension system comprising:
a plurality of pieces of elastomeric foam; and
a plurality of pieces of solid elastomer gel, each said piece of solid elastomer gel positioned between at least two pieces of said elastomeric foam such that each said plurality of pieces of elastomer gel is at least partially surrounded by said at least two pieces of elastomeric foam and such that said at least two pieces of elastomeric foam decreases the amount of deformation of said plurality of pieces of elastomer gel upon impact and assists said plurality of pieces of elastomer gel in returning to their original state after impact.

7. A suspension system as recited in claim 6, wherein said elastomeric foam is comprised of polyurethane.

8. A suspension system as recited in claim 6, wherein said elastomeric foam has a durometer range of 50 d to 65 d.

9. A suspension system as recited in claim 6, wherein said solid elastomer gel has a durometer range of 30 d to 45 d.
